(19) United States
(12) Patent Application Publication
(10) Pub. No.: US 2011/0040726 A1
(43) Pub. Date: Feb. 17, 2011

(54) Layout Manager

(76) Inventors: Nicholas Daryl Crosbie, Victoria (AU); Vittorio Cordioli, Victoria (AU)

Correspondence Address: FISH & RICHARDSON P.C. (SD), P.O. BOX 1022, MINNEAPOLIS, MN, 55440-1022, US

(21) Appl. No.: 12/678,709

(22) PCT Filed: Sep. 17, 2008
(86) PCT No.: PCT/AU08/01378

§ 371 Date: Jun. 11, 2010

Related U.S. Application Data
(60) Provisional application No. 60/972,948, filed on Sep. 17, 2007.

(51) Int. Cl. G06F 17/00; G06F 17/30

(52) U.S. Cl. 707/610; 715/243; 707/769; 707/E17.005; 707/E17.014

(57) ABSTRACT

A computer-implemented system for creating or managing layouts, comprising a browser application and one or more display clients for rendering data-oriented views. The browser application is user-operable to select or locate data sources and to select data-oriented views and thereby to control the browser application to control the display clients to render the selected data-oriented views based on the selected data sources. The browser application may include an icon module for generating increment icons, the increment icons being user-operable to select the data sources and the data-oriented views.

### RELATED APPLICATION

This application is based on and claims the benefit of the filing date of U.S. application No. 60/972,948 filed 17 Sep. 2007, the content of which as filed is incorporated herein by reference in its entirety.

### FIELD OF THE INVENTION

The present invention relates to a layout manager system and to a method for managing layouts, of particular but by no means exclusive application in simplifying the compositing, navigation, and data source provisioning of persistent data-oriented views.

### BACKGROUND OF THE INVENTION

In computing, information-based tasks may require a user to assimilate and manipulate multiple pieces of data in order to form comparisons between separate but related data sets. For example, a medical researcher or doctor may wish to compare one or more images obtained from a patient with a particular pathology with images obtained from a patient without that pathology.

In existing systems, a user typically must manually aggregate the required data into a meaningful (and possibly interactive) presentation comprising ‘display elements’ that form a ‘task-oriented view’.

Complex information processing, such as in the medical example referred to above, often requires the navigation and manipulation of several task-oriented views and—as a result—the interaction of multiple display elements, software applications and data sources. In such cases, the data source selection, configuration and on-screen organization (e.g. window placement) of the display elements of each task-oriented view places a considerable burden on the user. Moreover, the user's ability to select data sources for the purpose of making valid and informative comparisons can be limited by his or her incomplete knowledge of the various metadata differences that exist for a given collection of data sources.

### SUMMARY OF THE INVENTION

According to a first broad aspect, therefore, the present invention provides a computer-implemented system for creating or managing layouts, comprising:

a browser application; and
one or more display clients for rendering data-oriented views;
wherein said browser application is user-operable to select or locate data sources and to select data-oriented views and thereby to control said browser application to control said display clients to render said selected data-oriented views based on said selected data sources.

Thus, the system is able to generate a layout manager after having retrieved information stored in different locations (such as in files and databases, possibly in different formats), and analysed and evaluated that information.

The browser application may include an icon module for generating increment icons, the increment icons being user-operable to select the data sources and the data-oriented views.

Alternatively the browser application may include a tick box module for generating tick boxes, the tick boxes being user-operable to select the data sources.

In one embodiment, the browser application includes a user-operable menu for selecting the data sources and the data-oriented views.

The system may be configured to operate either supervised or unsupervised.

Moreover, in one embodiment the system is controllable to establish connections between computing devices and perform an analysis, and to output the results of the analysis (such as by displaying or printing the results) according to according to user definable settings.

For example, the system may be controllable to search for the data sources according to one or more user-defined search criteria.

The term ‘data-oriented view’ (DOV) is used herein to refer to a task-oriented view, where the display elements comprising the task-oriented view are provisioned by a single data source (as further explained below).

The skilled person will also appreciate that the browser application may be provided in the form of a ‘stand-alone’ browser application, or in the form of a plugin to, or module of, an existing application, such as an HTML browser (e.g. the Microsoft brand Internet Explorer browser, Mozilla brand Firefox browser or Apple brand Safari browser) or a file browser (e.g. Microsoft brand Explorer or Apple brand Finder). As will also be appreciated, however, the term ‘browser application’ refers to any application that can—or can be used to—browse, that is, search, explore, navigate or establish a connection (whether internally or externally), and with essentially any form of hardware or electronic content (whether in HTML or otherwise). It may comprise, for example, a stand-alone software application that facilitates access to and interaction between different hardware devices and software, according to the present invention, or be distributed. The hardware may comprise computers, mobile computing devices or mobile telephones . . . ), and the software may comprise databases and other data sets.

The data-oriented views may comprise display elements, the display clients rendering the data-oriented views by rendering the display elements.

The browser application may include a module for inviting one or more display clients to render the display elements constituting a data-oriented view or views, and for handling return states.

In one embodiment, the system includes a UUID module (typically comprises GUI elements and methods) that is operable by a user to associate a data-oriented view with a universal unique identifier, and configured to make the universal unique identifier available to a display client or clients responsible for rendering the data-oriented view and to the browser application.

The system may further comprise:
a synchronization service for providing persistent storage and synchronization of records pertaining to the data-oriented views;
a metadata service for creating, storing, accessing, discovering and exchanging metadata; and
an application launch service for allowing the browser application to open one or more display clients.

Moreover, in one embodiment, the system is user-operable to locate or collect information from a plurality of sources according to user defined criteria, and thereby to locate or collect information from databases, xml files, binary files, etc, whether stored locally or remotely.

The system may include an event notification system for managing notifications across multiple tasks.

In a particular embodiment, the invention can simplify the compositing, navigation, and data source selection of data-oriented views with a software architecture that includes synchronization, application launching and metadata services, an event-notification system, browser application and one or more display clients, GUI elements and methods for associating a data-oriented view with a Universal Unique Identifier (UUID), the UUID made available both to display clients responsible for rendering the data-oriented view's display elements and to the browser application, GUI elements and methods of the browser application that implement configurable and movable increment icons that allow the user to easily select data sources and data-oriented views, and invites relevant display clients to render the display elements constituting a data-oriented view or views, and handles return states, a set of standard methods that display clients must support in order to participate in the compositing and rendering of one or more data-oriented views, where those methods are implemented through a plugin architecture.

The system may also include a metadata service configured to control displaying of data source metadata presented for browsing or operation of the increment icons.

The system may also be adapted to generate increment icons if needed or according to a user configurable default setting.

According to a second broad aspect, the present invention provides a computer-implemented method for creating or managing layouts, comprising:
operating a browser application to select or locate data sources and to select data-oriented views; and
controlling the browser application to control the display clients to render the selected data-oriented views based on the selected data sources.

The method may include generating increment icons with a module of the browser application, and operating the increment icons to the select data sources and the data-oriented views.

The method may include performing the functions of any or all of the features of the above-described system.

The invention also provides computer program code that when executed by a processor implements the method described above. The invention also provides a computer readable medium comprising that program code.

In addition, the invention provides a data packet or packets comprising computer program code that when executed by a processor implements the method described above.

### BRIEF DESCRIPTION OF THE DRAWING

In order that the invention may be more clearly ascertained, embodiments will now be described, by way of example, with reference to the accompanying drawing, in which:

FIG. 1 is a schematic view of a system comprising a software stack according to an embodiment of the present invention;

FIG. 2 is a schematic view of a graphical canvas generated by the software stack of FIG. 1, on which are displayed four exemplary data-oriented views (DOVs), each comprising display elements (DEs), rendered by respective display clients (DCs) of the software stack;

FIG. 3 illustrates an active window ('Views Table') that is displayed when the ‘Views . . . ’ menu option is selected;

FIG. 4 illustrates a flow diagram describing the methods executed by the browser application when the ‘+’ button described with respect to FIG. 3 is left-clicked;

FIG. 5A illustrates an active window (‘Configure Browser Table’) that is displayed when the ‘Configure Browser . . . ’ menu option is selected according to this embodiment;

FIG. 5B illustrates the Configure Browser Table of FIG. 5A after the manipulation of various attributes and their display;

FIG. 6 is a flow diagram of a method executed by the browser application when the show attributes button of the Configure Browser Table of FIG. 5A is left-clicked;

FIG. 7 is a view of a browser document according to certain teachings of the present invention;

FIG. 8A is a schematic illustration of a Configurable and Movable Increment Icon (CAMII) entity-relationship data structure according to this embodiment of the present invention;

FIG. 8B is a schematic illustration of an exemplary drop-down list, accessed by right-clicking the CAMII of FIG. 8A, used for indirectly setting the value of a CAMII's dovUUID property;

FIG. 9 is a flow diagram of methods executed by the browser application and display clients during the updating of an ActiveDOV record according to this embodiment; and

FIG. 10 illustrates the contents of an exemplary temporary file, created, written and read during the compositing of a view;

FIG. 11 is an example of the output displayed to a display and resulting from the settings shown in FIG. 7;

FIG. 12 is an example of the output displayed to a display and resulting from the use of a system according to an embodiment of the present invention operating unsupervised according to user defined criteria; and

FIG. 13 is a flow diagram of the method of the embodiment of FIG. 12.

### DETAILED DESCRIPTION OF THE EMBODIMENTS

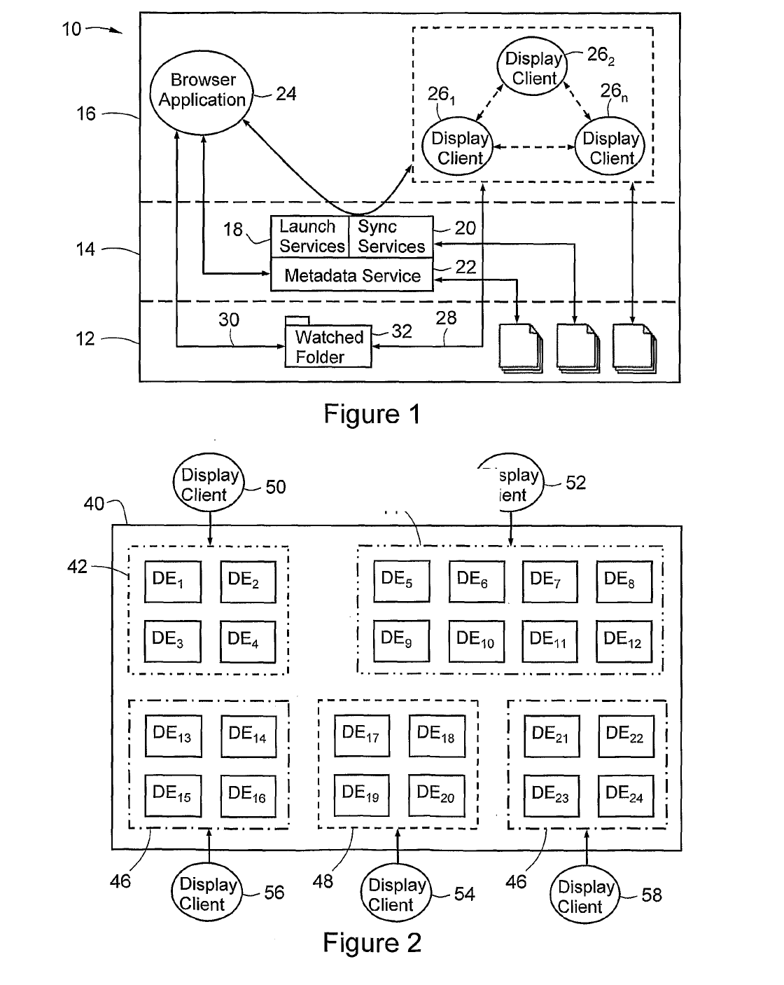

FIG. 1 is a schematic view of a system comprising a software stack 10 according to an embodiment of the present invention. Only components germane to the understanding of the present invention are shown. The elements of software stack 10 may be regarded as discrete modules. Software stack 10 is configured for execution on one or more computing devices in a computing environment, and to control those devices to perform the tasks described below.

Software stack 10 comprises a file system and system services layer 12 (the lowest layer), an application frameworks and services layer 14, and an application layer 16 (the highest layer). (Some other layers of software and firmware are omitted for clarity.) Generally, the software elements of any particular layer use resources from the layers below and provide services to the layers above, but in practice not all components of a particular software element behave entirely in that manner.

File system and system services layer 12 includes a plurality of files and directories, which are maintained by the file system of the computing environment. Application frameworks and services layer 14 is an amalgamation of functions commonly expressed as two layers (e.g. an applications frameworks layer and an applications services layer). In this embodiment, both of these layers 12, 14 provide high-level and, commonly, functional support for application programs that reside in application layer 16.

Application frameworks and services layer 14 includes an application launching service in the form of Launch Service 18, a Synchronization Service 20 and a Metadata Service 22. The Launch Service 18 allows a running Browser Application 24 to open (i.e. launch or activate) one or more Display Clients 26₁, 26₂, . . . , 26ₙ, and comprises a high-level framework or API such as Apple brand LaunchServices Framework. It should be noted that, because software stack 10 is configured for execution on one or more computing devices, if more than one Display Client participates in rendering a particular DOV, those Display Clients may execute on a plurality of computing devices.

In this embodiment, Synchronization Service 20 is provided through a high-level framework or API that provides efficient persistent storage and synchronization of DOV records, and uses Extensible Markup Language (XML) for its data model. Suitable examples are Apple brand SyncServices Framework, Microsoft brand Synchronization Framework for ADO.NET, or the SyncML API (JAVA). Metadata Service 22 is provided through a high-level framework or API for the creation, storage, access, discovery, and exchange of metadata, such as Apple brand ‘Spotlight technology’, Microsoft brand ADO.NET, or JAVA Metadata Interface.

Software stack 10 also includes an event-notification system, such as Kqueue, or an equivalent higher-level event-notification API that manages notifications across multiple tasks (such as Apple brand Cocoa NSDistributedNotificationCenter API or the SUN brand Java System Message Queue API), to facilitate the transmission (see data flows 28, 30 in FIG. 1) of targeted event-notification messages to Browser Application 24 and Display Clients Display Clients 26₁, 26₂, . . . , 26ₙ upon changes to a watched memory 32, in the form of a watched memory address (such as an array) or a watched persistent store (such as a directory folder on a hard disk). In this embodiment, watched memory 32 comprises a watched folder, so is referred to hereinafter as the ‘watched folder.’

FIG. 2 is a schematic view of a graphical canvas 40 generated by software stack 10 of FIG. 1, on which are displayed four exemplary data-oriented views (DOVs) generated by software stack 10. First, second, third and fourth DOVs 42, 44, 46, 48 each comprise one or more display elements (DEs), each of which may comprise a table, a graph, an image, or any other element capable of being rendered or otherwise computer-generated (including an audio element) by a display client. In this example first DOV 42 comprises display elements DE₁, DE₂, DE₃ and DE₄. These display elements constitute a ‘data source’ comprising discrete visual representations of a data set (or a subset thereof) or plural related data sets (or subsets thereof), resolved by a single URI (termed dataSourceURI); in this example first DOV 42 has the notional dataSourceURI http://path/to/data_sourceA.FCS).

Second DOV 44 comprises display elements DE₅, DE₆, DE₇, DE₈, DE₉, DE₁₀, DE₁₁ and DE₁₂, and has notional dataSourceURI http://path/to/data_sourceB.RDF. Third DOV 46 comprises display elements DE₁₃, DE₁₄, DE₁₅, DE₁₆, DE₂₁, DE₂₂, DE₂₃ and DE₂₄, with notional dataSourceURI file:///path/to/data_sourceC.RDF. Fourth DOV 48 comprises display elements DE₁₇, DE₁₈, DE₁₉ and DE₂₀, with notional dataSourceURI http://path/to/data_sourceD.FCS.

The dataSourceURI of a DOV can be any legal absolute or relative path to the corresponding data source. The term ‘resolved’ refers herein to the ability to retrieve data, that is, the data's address is given by the dataSourceURI or, as may be in the case of hyperlinked data (for example, HTML or RDF files), can be found by traversing a path, commencing with the dataSourceURI. Graphical canvas 40 is commonly contained on the display area of a single display device, such as a computer monitor, but in some embodiments spans plural such display devices with each display device mapping a portion of the canvas.

A display element is often contained within its own window (controlled by a window server), though this is not essential and in this embodiment plural display elements may be present in a given window. Display elements forming any particular DOV may be rendered contiguously (e.g. display elements DE₁, DE₂, DE₃ and DE₄ constituting first DOV 42 or display elements DE₅, DE₆, DE₇, DE₈, DE₉, DE₁₀, DE₁₁ and DE₁₂ constituting second DOV 44), or non-contiguously (e.g. display elements DE₁₃, DE₁₄, DE₁₅ and DE₁₆ in the lower left of display canvas 40 and display elements DE₂₁, DE₂₂, DE₂₃ and DE₂₄ in the lower right of the display canvas 40, which together constitute third DOV 46).

One or more of Display Clients 26₁, 26₂, . . . , 26ₙ are responsible for rendering the display elements that constitute DOVs 42, 44, 46, 48. In the example of FIG. 2, the display elements constituting first, second and fourth DOVs 42, 44, 48 are rendered by Display Clients 50, 52, 54 respectively. The display elements constituting third DOV 46 are rendered by two Display Clients 56, 58: Display Client 56 renders elements DE₁₃, DE₁₄, DE₁₅ and DE₁₆; Display Client 58 renders elements DE₂₁, DE₂₂, DE₂₃ and DE₂₄.

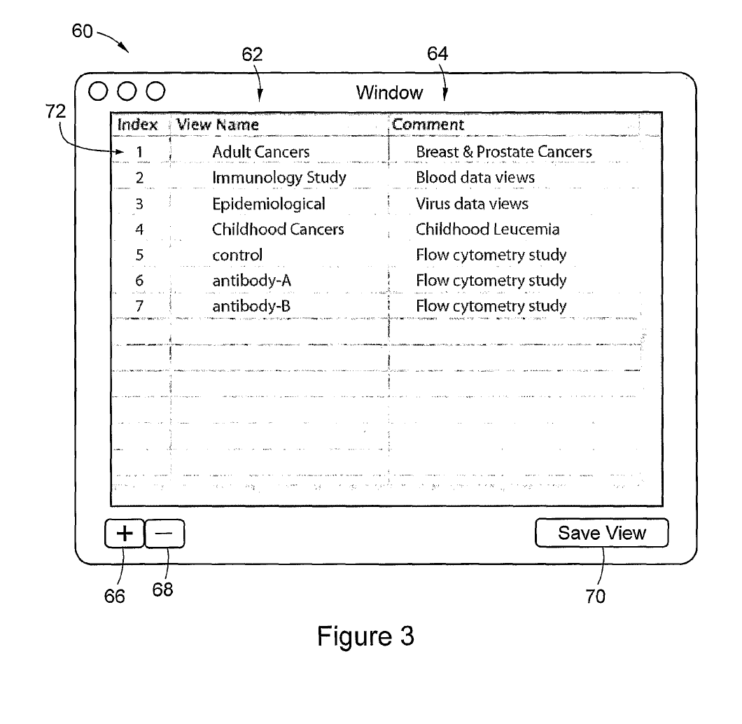

Browser Application 24 provides a ‘Views . . . ’ menu option that, when selected, displays in an active window a ‘Views Table’ that summarizes the previously configured data-oriented views. FIG. 3 is a schematic view of an exemplary Views Table 60, displayed following the selection of the ‘Views . . . ’ menu option, which comprises seven views each associated with a title (in a ‘View Name’ column 62) and comments (in a ‘Comment’ column 64). Views Table 60 includes a ‘+’ button 66, for activating the composition of a ViewRecord (discussed below), a ‘−’ button 68, for deleting one or plural DOV record and a ‘Save View’ button 70.

In this embodiment, Display Clients support a set of standard methods in order to participate in the compositing and rendering of one or more DOVs; these methods are implemented through a plugin architecture. Table 1 provides an example of such a plugin architecture, methods of which are discussed below.

TABLE 1
Methods of exemplary Display Client plugin

| | | |
|---|---|---|
| | RETURN | |
| METHOD | TYPE | DESCRIPTION |

DISPLAY ELEMENT SELECTION & WINDOW HIGHLIGHTING

| | | |
|---|---|---|
| displayElement | void | User-invoked method to enable |
| Selection | | recording selection of DE(s) |
| | | for the purpose of composing |
| | | a DOV record and a |
| | | DisplayElements record. May |
| | | include methods to provision |
| | | and select a menu item in a |
| | | context-dependent menu |
| | | exposed, for example, by a |
| | | right-mouse-click of the |
| | | display element. Calls |
| | | setWindowBorderSelection |
| | | Method. |
| setWindowBorder | void | Called by |
| Selection | | displayElementSelection to |
| | | highlight the selection of |
| | | display elements during the |
| | | composition of a DOV. |

COMPOSING A DOV RECORD

| | | |
|---|---|---|
| handleWatchedFolder | BOOL. | Responds to notification of a |
| FileRenameEvent | YES if | file RENAME event in watched |
| | successful. | folder: |
| | | Determine if Display Client |
| | | can participate in |
| | | compositing a DOV record. If |
| | | NO, display error message to |
| | | the user. If YES, then |
| | | retrieve the UUID from the |
| | | renamed temporary file (the |
| | | first line of the temporary |
| | | file). |
| handleDisplay | BOOL. | Call only if handleWatched |
| ElementSelection | YES if | FolderFileRenameEvent returns |
| | successful. | YES. |
| | | Respond to notifications of |
| | | selected display elements |
| | | during compositing of DOV |
| | | record and DisplayElements |
| | | record: |
| | | write the displayClientID to |
| | | the end of the temporary file |
| | | upon the selection of the |
| | | first-selected DE, but not |
| | | subsequent selections of |
| | | DE(s). |
| handleWatchedFolder | BOOL. | Respond to notification of |
| FileDeletionEvent | YES if | file DELETION event in |
| | successful. | watched folder: |
| | | Create a persistent store, in |
| | | the form of DisplayElements |
| | | record, of the configurations |
| | | required to recreate the |
| | | DOV's DE(s) (given the |
| | | provision of a |
| | | dataSourceURI(s). Write out |
| | | the DisplayElements' dovUUID |
| | | property with the dovUUID |
| | | retrieved from the temporary |
| | | file. |

PARTICIPATE IN A DOV SESSION

| | | |
|---|---|---|
| handleRequestSync | BOOL. | Negotiate whether or not to |
| ActiveDOV | YES if | join a Sync Session for |
| | successful. | updating ActiveDOV record |
| | | properties. |
| handleChangedActive | BOOL. | Respond to changes to |
| DOVPersistentStore | YES if | ActiveDOV record properties: |
| | successful. | (i) use the ActiveDOV dovUUID |
| | | value(s) as key(s) for |
| | | retrieval of the relevant |
| | | DisplayElements record(s). |
| | | (ii) use the configuration |
| | | information contained in the |
| | | DisplayElements record(s), |
| | | and the value(s) of ActiveDOV |
| | | dovColor property (Table 2) |
| | | to render the DOV(s). |
| | | Calls setWindowBorderColor |
| | | Returns YES if successful, NO |
| | | otherwise. |
| setWindowBorder | void | Set to ActiveDov's dovColor |
| Color | | value(s) (Table 2). Called by |
| | | handleChangedActiveDOV |
| | | PersistentStore. |

END PARTICIPATION IN A DOV SESSION

| | | |
|---|---|---|
| handleRequestToExit | BOOL. | User-invoked method to cease |
| DOV Session | YES if | participation in a DOV |
| | successful. | session. User access to this |
| | | method may be provided by a |
| | | menu inserted into the |
| | | Display Client's main menu. |

TABLE 2
Exemplary Sync properties for ‘ActiveDOV’ record

| KEY | TYPE | DESCRIPTION/VALUE |
|---|---|---|
| dovUUID | NSArray (NString₁ . . . , | Universal Unique |
| | NString_{N}) | Identifier for |
| | | each DOV. |
| dataSourceURI | NSArray (NSURL₁ . . . , | Data Source URI |
| | NSURL_{N}) | for each DOV. |
| dovColor | NSArray (NSColor₁ . . . , | Color setting for |
| | NSColor_{N}) | each DOV. |

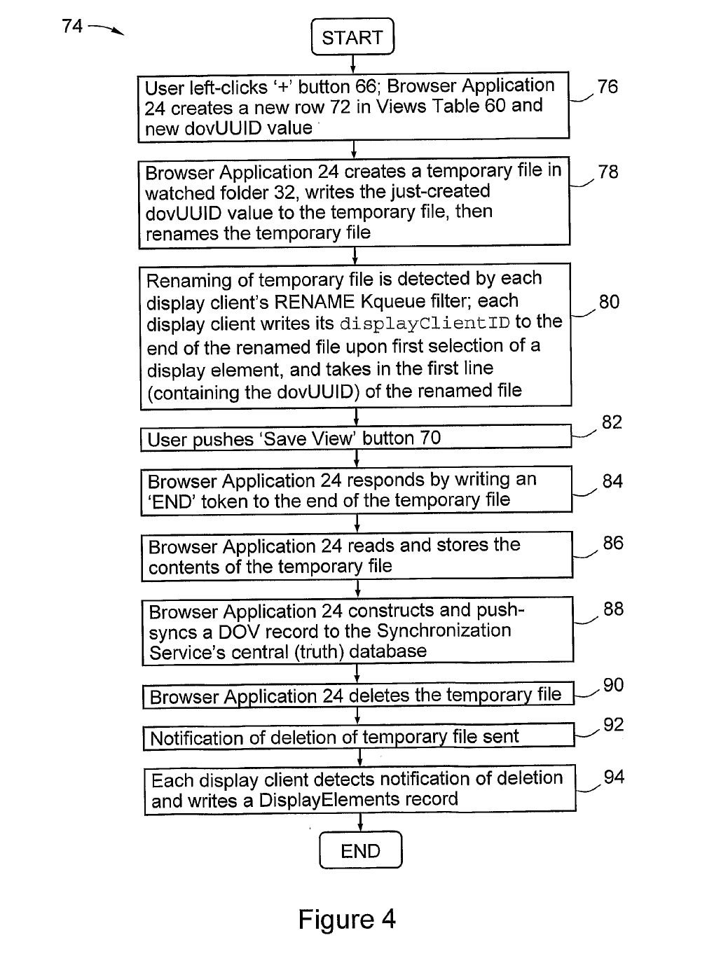

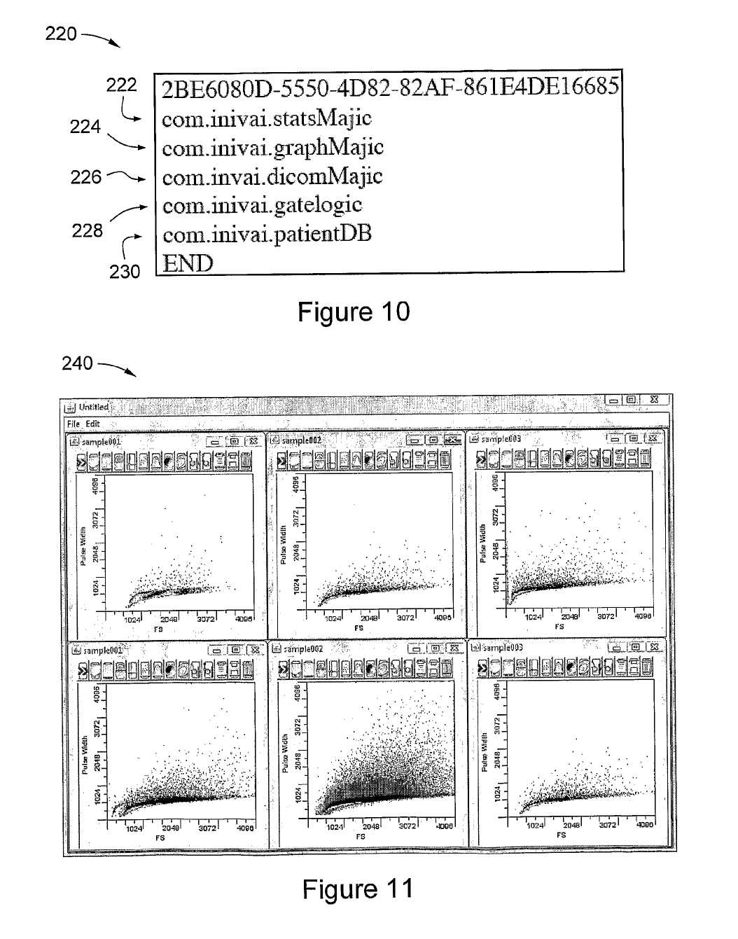

According to this embodiment, a DOV is associated with a UUID (Universally Unique Identifier) by the creation of a ViewRecord. The ViewRecord of each DOV is composed through the combined action of Browser Application 24 and the Display Client(s) associated with that DOV. The composition of a ViewRecord is summarized in flow diagram 74 of FIG. 4. At step 76, the user commences by left-clicking on the ‘+’ button 66 of Views Table 60, whereupon the Browser Application 24 creates a new row 72 in Views Table 60 and generates a UUID which is then associated with that row; hence, each row of Views Table 60 has a one to one relationship with a DOV entity. Browser Application 24 then creates, at step 78, a temporary file in a watched folder, writes the just-created UUID to the temporary file 84, then renames the temporary file. At step 80 a notification of this ‘rename event’ is immediately detected by each DOV-compliant Display Client through a notification mechanism (in this embodiment RENAME Kqueue filter), whereupon each such Display Client, by invocation of its handleWatchedFolderRenameEvent (see Table 1) writes a displayClientID (see entries 222, 224, 226, 228, 230 of exemplary temporary file 220 of FIG. 10), such as in reverse DNS format, to the end of the renamed temporary file upon selection of a display element (but not subsequent selections of display elements), then reads and stores the first line of the temporary file (which contains the UUID) in, for example, an in-memory array.

Through the action of each Display Client's displayElementSelection and setWindowBorderSelection methods (see Table 1), the display elements thus selected are marked as having been selected for inclusion in a DOV, such as by setting their window border to red for the duration of the selection process. Other display client methods employed are handleWatchedFolderFileRenameEvent and handleDisplayElementSelection.

At step 82 the user completes the process of composing a view by left-clicking the ‘Save View’ button 70. This prompts, at step 84, Browser Application 24 to write an ‘END’ token (which, in combination with the presence of the UUID and at least one displayClientID, flags a complete DOV record) to the end of the aforementioned temporary file; at step 86, Browser Application 24 reads and parses the contents of the temporary file (an example of which is shown at 220 in FIG. 10) and, at step 88, uses the parsed temporary file to construct a DOV record (see Table 3) and push-syncs that record to the Synchronization Service's central (truth) database.

TABLE 3
Exemplary Sync properties for ‘DOV’ record

| Key | Type | Description/Value |
|---|---|---|
| dovUUID | NSString | Universal Unique |
| | | Identifier for DOV. |
| displayClientID | NSString₁ . . . , | Unique identifier for |
| | NSString_{N} | each Display Client, in |
| | | standard format (e.g. |
| | | reverse DNS-style). |

At step 90, Browser Application 24 deletes the temporary file. Then, at step 92, upon the user's left-clicking the ‘end selection’ button, a notification of the deletion of the temporary file is sent; at step 94 this notification is detected by each DOV-participating display client's DELETE Kqueue event filter, instructing the DOV-participating display client, through the action of their handleWatchedFolderFileDeletionEvent method (see Table 1), to store—as a ‘DisplayElements’ record (see Table 4)-all configuration information required to reconstruct those display element(s) that it contributed to the DOV.

TABLE 4
Exemplary Sync properties for ‘DisplayElements’
record

| Key | Type | Description/Value |
|---|---|---|
| dovUUID | NSString | Universal Unique Identifier |
| | | for DOV. |
| displayElements | NSData | Binary archive containing |
| | | configuration information |
| | | for each Display Element. |

### Configuring and Populating the Browser

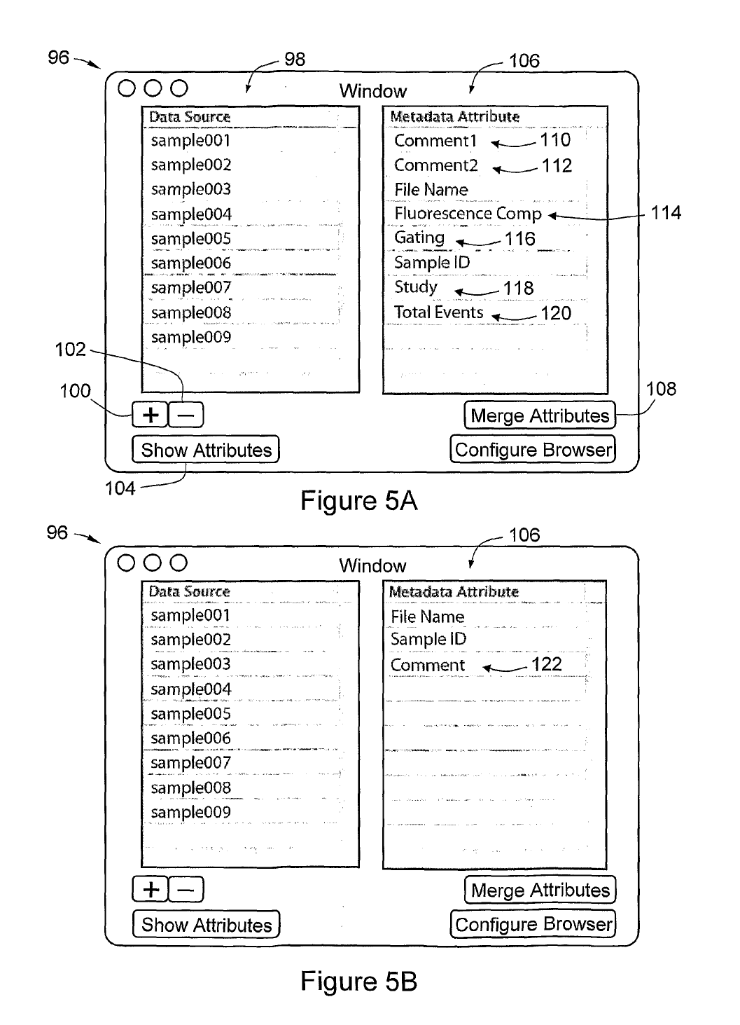

The user configures a browser document with data sources and associated metadata with the ‘configure browser’ table, shown schematically at 96 in FIG. 5A. The user populates the ‘data source’ column 98 of configure browser table 96 with a list of data sources (typically files) of potential interest by copy-and-paste or drag-and-drop, such as with a file browser such as Apple brand Finder or Microsoft brand Window's Explorer. The user may also directly add and delete files with the add button 100 and delete button 102, respectively. (The add button 100 retrieves the system's file browser, with which the user can select additional files.) Upon population of the data source column 98 with a list of data source files, a show attributes button 104 is enabled.

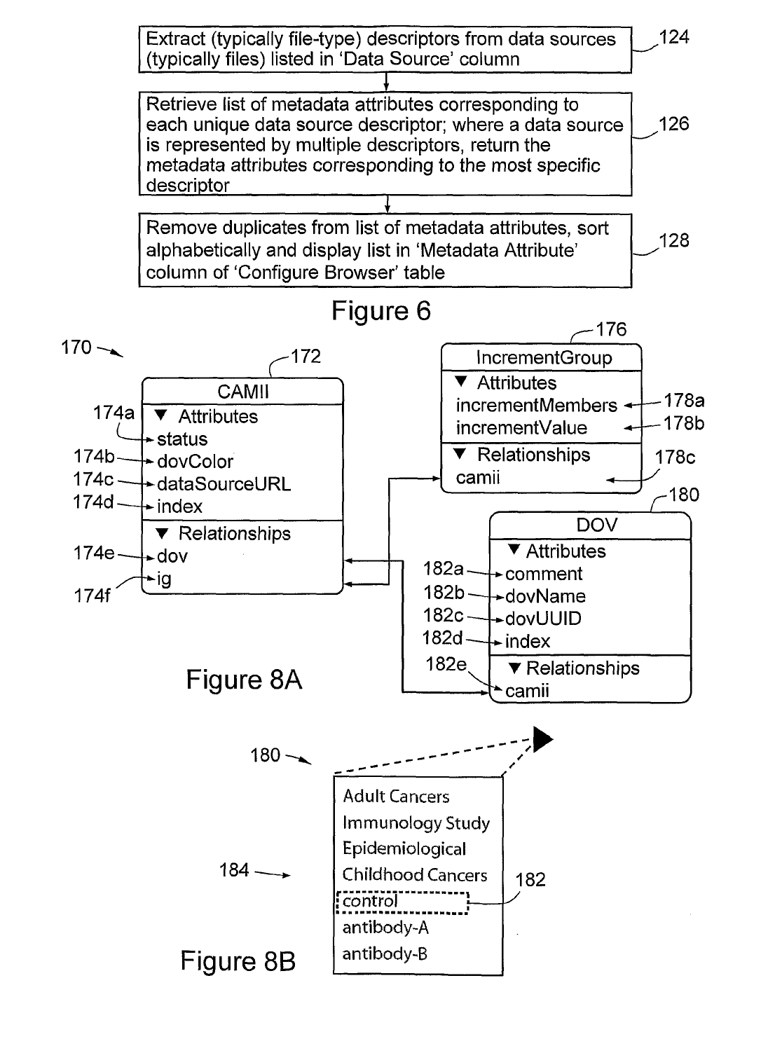

Pressing the show attributes button 104 causes the browser client to execute a method (shown as a flow diagram in FIG. 6) that populates a metadata attribute column 106 with a list of unique metadata attributes, sorted alphabetically. The user can subsequently reorder (drag-and-drop between column rows), delete (delete button 102 or delete key action) or merge metadata attributes listed in the metadata attribute column 106. To merge metadata attributes, the user selects the attributes to merge, then left-clicks a merge attributes button 108, whereupon the user is prompted to enter a new name for the merged attributes. For example, in the hypothetical example of FIG. 5A, the metadata attributes ‘Comment1’ 110 and ‘Comment2’ 112 could be merged. Additionally, the metadata attributes ‘Fluorescence Comp’ 114, ‘Gating’ 116, ‘Study’ 118 and ‘Total Events’ 120 might be removed from metadata attribute column 106. The effect of manipulating these attributes and their display is illustrated in FIG. 5B, in which Comment1 110 and Comment2 112 have been merged to form a single Comment attribute 122, Fluorescence Comp 114, Gating 116, Study 118 and Total Events 120 have been removed, and the remaining metadata attributes in metadata attribute column 106 have been reordered.

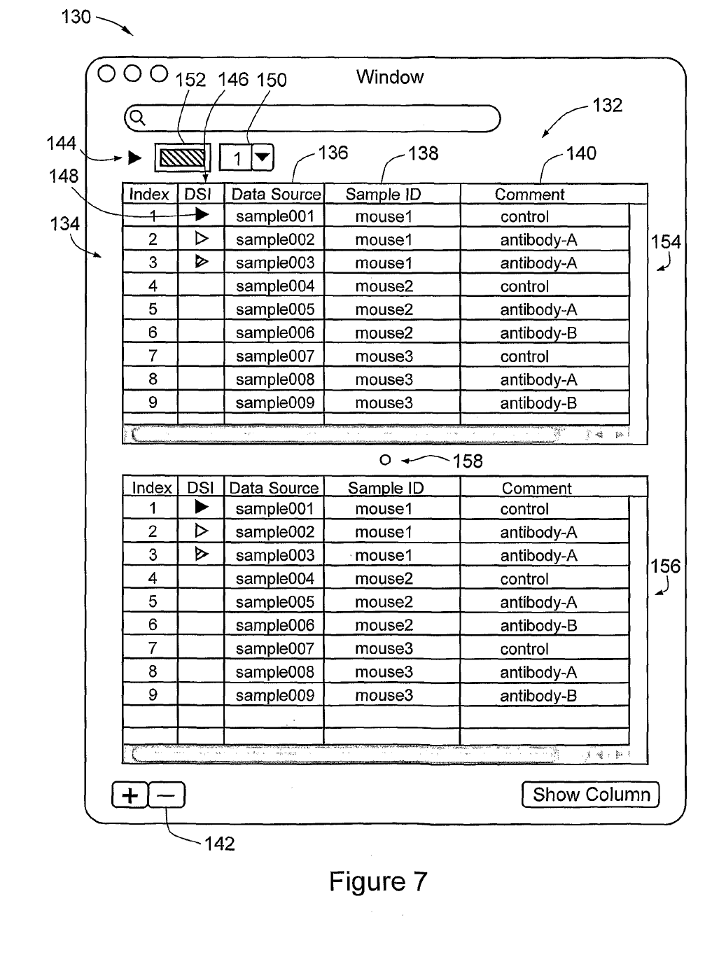

FIG. 7 is a view of a browser document 130 according to this embodiment of the present invention. Browser document 130 includes a browser document table 132 comprising rows 134, each of which identifies a single file (in Data Source column 136) and associated metadata that is organized into columns that are controllably shown or hidden; the set of metadata columns is determined by the metadata attributes selected by the user in their interaction with the configure browser table 96 of FIG. 5A. In the illustrated example, the displayed metadata columns are Data Source 136, Sample ID column 138 and Comment column 140.

Rows 134 and associated data may be deleted (by selecting the respective row(s) and then activating—typically by left-clicking—delete button 142) or copied within and between browser documents.

Horizontal and vertical ‘split views’ can be created to facilitate effective navigation of large browser documents; this is also depicted in this figure, in which the view is divided in two panes 154, 156. That this mode of display is in operation is flagged to the user by dimple 158.

The user can associate one or more DOVs with a Configurable and Movable Increment Icon (or CAMII, discussed further below) by left-click-selecting one or more rows 72 of Views Table 60 (see FIG. 3) and dragging (i.e. with mouse button depressed) to a target CAMII. Releasing the mouse button with the target CAMII ‘in focus’ associates the one or more DOVs with that CAMII, and populates a drop-down list (see FIG. 8B) from which the user can select a DOV (as is described below). A DOV may be associated with any number of CAMII.

In one variation, software stack 10 can generate one or more CAMII and one or more split views to display entities such as files or records from databases that display similarities or dissimilarities (described in greater detail below).

### Configurable and Movable Increment Icons (CAMIIs)

A valuable functional aspect provided by this embodiment of the present invention is the ability to create and use one or more ‘Configurable and Movable Increment Icons’ (CAMIIs). A user can create a CAMII by dragging an icon from the CAMII well 144 (of browser document 130 of FIG. 7) onto browser document table 132 (such as in DSI column 146 at 148).

The user may locate a newly created CAMII, or relocate an existing CAMII, at any row 134 of browser table 132 that i) holds data (that is, a CAMII cannot be positioned at an empty row), and ii) does not already have a CAMII. A user effects relocation of a CAMII by any of three methods: (i) drag-and-drop, (ii) copy-and-paste, or (iii) use of an UP or DOWN key (or the like). With CAMII relocation methods (i) and (ii), the user is free to vertically reposition a CAMII across any number of table rows, whereas the extent of vertical movement of a CAMII by relocation method (iii) depends on the ‘increment behaviour’ of a CAMII, which is itself configurable (discussed below).

A CAMII's vertical position within browser document table 132 (i.e. the row 134 in which it is located) sets the contents of its dataSourceURI attribute (discussed below), which are updated upon each CAMII relocation event. A CAMII may be deleted by left-click-selecting it and pressing delete 142 or selecting ‘delete’ from an application menu.

Properties determining the configuration of a CAMII are set and accessed via a CAMII entity-relationship data structure. FIG. 8A is a schematic illustration of a CAMII entity-relationship data structure 170 according to one embodiment of the present invention. Referring to FIG. 8A, the CAMII entity-relationship data structure includes the following entities, attributes and relationships: a CAMII entity 172 containing the attributes status 174a, dovColor 174b, dataSourceURI 174c, and index 174d (where dovColor and dataSourceURI are display properties), and the relationships dov 174e and ig 174f; an IncrementGroup entity 176 containing the attributes incrementMembers 178a and incrementValue 178b, and the relationship camii 178c (which is the inverse relationship of ig relationship 174f of CAMII entity 172); a DOV entity 180 containing the attributes comment 182a, dovName 182b, dovUUID 182c and index 182d, and the relationship camii 182e (the inverse relationship of dov relationship 174e of CAMII entity 172).

Each CAMII is mapped to one instance of a CAMII entity. The status attribute 174a, which may be modelled as a Boolean, refers to the active (Boolean value=YES) or inactive (Boolean value=NO) status of a CAMII. When created, each CAMII defaults to an inactive status, which status is indicated to the user, such as by being displayed in a different colour or grayed out (not shown). A CAMII can be toggled between active or inactive status by double-clicking it with the left mouse button.

Referring to FIG. 7, to set the increment behaviour of a CAMII, the user selects the relevant CAMII then chooses or enters an increment value using a combo box user interface element 150. The increment behaviour of more than one CAMII can be entered as a group, that is, by selecting two or more CAMII and then entering an increment value with user interface element 150. When the increment behaviour of a CAMII is entered in group fashion, the thus configured CAMII will move in tandem with its group members, that is, moving any CAMII of that group will cause all other CAMIIs of that group to move by the increment value set for the group. Properties of the increment value of a CAMII are held in the IncrementGroup entity 176, and are accessed by each CAMII object via its ig relationship 174f. The incrementMembers attribute 178a contains an array of CAMII entity object identifiers, one object identifier for each CAMII that ‘participates’ in a given increment behaviour configuration. The incrementValue attribute 178b, which may be modelled as an integer, contains the increment value (i.e. the number of rows one or more CAMIIs will move up or down in response to a user's initiating CAMII relocation) for the ‘increment group’ and defaults to a value of 1.

FIG. 8B is a schematic illustration of a drop-down list 180, accessed by right-clicking a CAMII, for example CAMII 148 of FIG. 7, and used for indirectly setting the value of a CAMII's dovUUID property. Referring to FIG. 8B, right-clicking a CAMII prompts the display of drop-down list 180, from which the user can left-click-select a DOV 182 from a list of the one or more available DOVs 184 associated with the CAMII through the mechanism described above. Upon selection of a DOV, the name of the selected DOV 182 (dovName) and associated comment (comment) properties are henceforth displayed as a ‘tool tip’ upon mousing (i.e. hovering) over a CAMII (unless no DOV is selected, in which case the default value ‘none’ is displayed).

The user is able to graphically communicate an association between the display elements of a DOV with an associated CAMII by left-click-selecting a CAMII and selecting ‘highlight display elements’ from an application menu that is then displayed. For example, the colour of the selected CAMII can be set via a colour well 152; the resulting colour setting is written to the colour attribute, colour 174b, and sets the ActiveDOV property, dovColor (see Table 2). The selected colour is applied to the display element(s) of the active DOV to highlight them, by setting the colour of their associated window frame upon DOV invocation. (Display clients call the setWindowBorderColor method, described below.) Highlighting a DOV's display elements enables the user to readily distinguish and identify those elements and their associated data source where multiple DOVs are simultaneously in view on a graphical canvas. By left-clicking a CAMII and selecting ‘remove display highlights’ from the application menu displayed in response, the user removes the highlighting effect from display elements associated with its active DOV.

In a variation of this embodiment, browser document 130 includes a user-operable menu to facilitate the selection of data sources and data-oriented views. Users can select contiguous or discontinuous rows, and can select from the menu to move up or down one or two, and conceivably more, rows (such as by selecting ‘jump up one row’, ‘jump down one row’, ‘jump up two rows’ or ‘jump down two rows’).

For example, in use the user might select two contiguous rows from upper pane 154 and two (non-contiguous) rows from lower pane 156. The system is configured to respond by comparing the selected rows, displaying the rows on the screen and—in response to the user clicking the down and up arrow—display to the screen the resulting windows.

If the user wishes to change his or her selection having, for example, previously selected rows 3 and 4 from upper pane 154, he or she may subsequently jump to—and select for display—rows 5 and 6 without having to select rows 4 and 5 first.

### Display Client Launch and Rendering of Display Elements

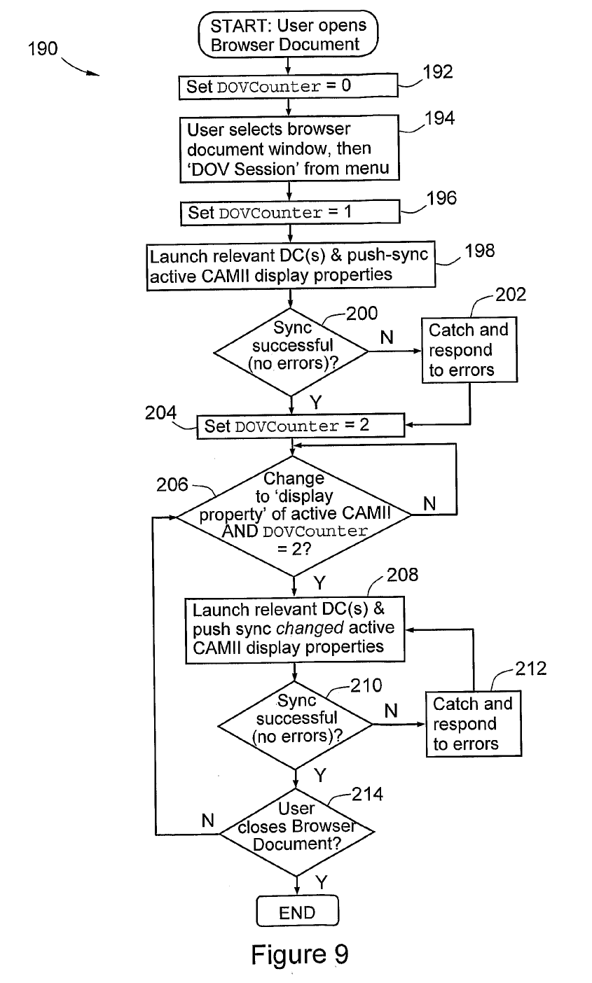

FIG. 9 is a flow diagram 190 of the methods executed by the browser application and display clients during the updating of an ActiveDOV record according to this embodiment. As illustrated in FIG. 9, the methods commence in response to a user's opening a browser document. Thus, at step 192, DOVCounter is set to 0; while DOVCounter has a value of 0, the browser application document can be described as in an inactive mode. In this mode, any change to the properties of a CAMII will not cause the invocation (display client launch and DE rendering) of the associated DOV(s).

At step 194, the user selects a browser document window, then a ‘DOV Session’ from the browser application menu. At step 196, the DOVCounter value of the selected browser document is set to 1. At step 198, the browser application immediately launches (via Launch Services) all display clients required for display of the DOV(s) that are associated with active CAMIIs, and push syncs that browser document's active CAMII display properties (updating ActiveDOV record(s)—see Table 2) to the Synchronization Service's central (truth) database. If at step 200 synchronization of the aforementioned display properties is found not to have been successful, processing continues at step 202 where the errors are caught and responded to. Processing then continues at step 204. If at step 200 synchronization of the aforementioned display properties is found to have been successful, processing proceeds directly to step 204.

At step 204, DOVCounter is set to 2. In this mode, a change to any display property of an active DOV (at step 206) will cause the system to respond, at step 208, by launching the relevant display clients (via Launch Services) and to push sync changed active CAMII display properties (updating ActiveDOV record(s)—see Table 2) to Sync Services' truth Database.

If at step 210 synchronization of the display properties is found not to have been successful, processing continues at step 212 where the errors are caught and responded to, after which processes returns to step 208. If at step 210 synchronization of the display properties is found to have been successful, processing continues at step 214.

At step 214, software stack 10 determines whether the user has closed the Browser Document. If so, processing ends. Otherwise, processing returns to step 206.

Display clients render a DOV or DOVs through the invocation of three methods (see Table 1). A display clients' handleRequestSyncActiveDOV negotiates whether or not to join a synchronization session for updating its ActiveDOV record properties. Upon agreeing to join the sync session (which may depend on display client-specific custom logic, such as on the availability of suitable resources for DOV rendering), the handleChangedActiveDOVPersistentStore method receives a notification that its ActiveDOV record has changed, whereupon it uses the ActiveDOV dovUUID value(s) as key(s) for retrieval of the relevant DisplayElements record(s). Subsequently, it uses the configuration information contained in the DisplayElements record(s), and the value(s) of ActiveDOV dovColor property (see Table 2) to render the DOV or DOVs.

FIG. 11 is an example of the output 240 displayed to a display and resulting from the settings shown in FIG. 7. However, in another variation of this embodiment, software stack 10 can generate essentially the same result by conducting an independent search for similarities (or indeed dissimilarities) in some parameter or parameters of the data using, for example, statistical analysis, cluster analysis or geometric figures.

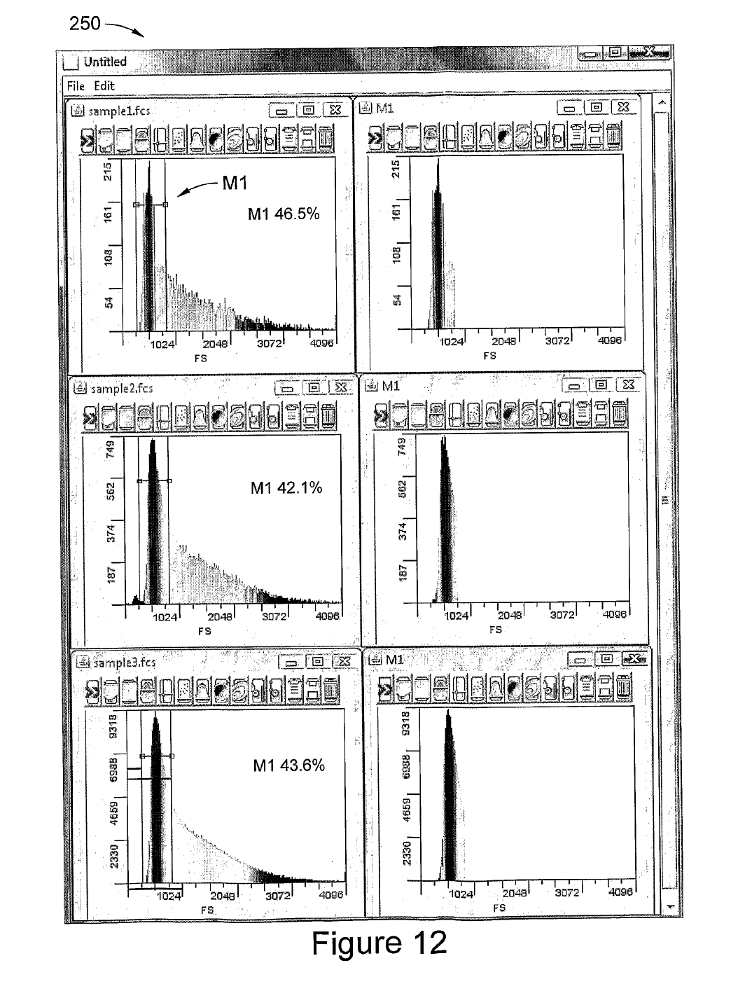

In one example, software stack 10 can be controlled to identify all data files (from a user specified or defined list of files) that meet some user defined criterion. In the exemplary output 250 shown in FIG. 12, the parameter is that the data files should include a similar percentage of events in the range identified by a specified marker M1 (from channel 264 to channel 834 in this example), where ‘similar’ means to within—say—10%. This can be done in a supervised or unsupervised manner.

The results are outputted to a display, as shown at 250 in FIG. 12. In this example, three files have been located (viz. sample1.fcs, sample2.fcs and sample3.fcs), and are displayed at 250 along with the percentage of events in the range identified by marker M1 (respectively 46.5%, 42.1% and 43.6%) and plots—on the right of FIG. 12—of the data in the range of marker M1.

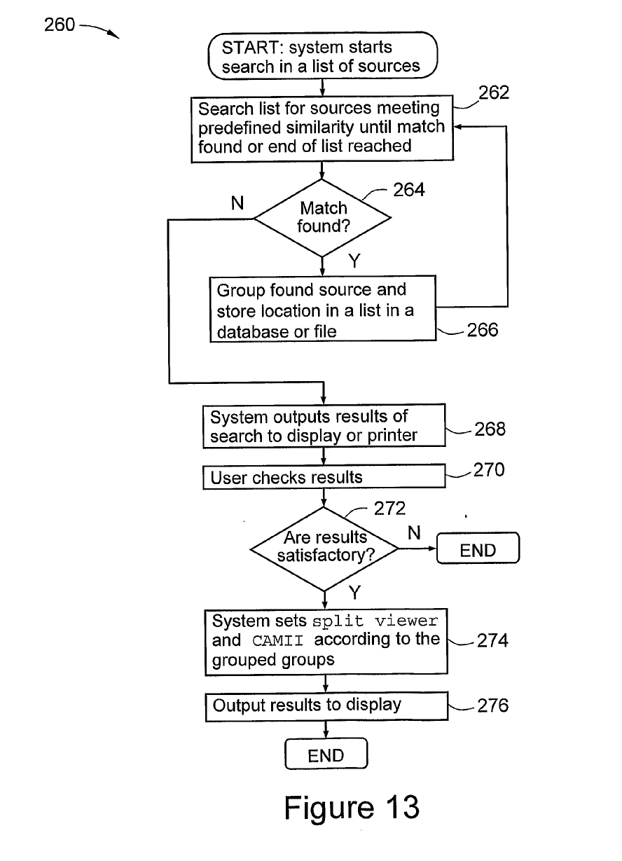

FIG. 13 is a flow diagram 260 of the method of this embodiment whereby the system searches a set list of available sources (databases, files, etc) for such similarities. Thus, at step 262 the system searches the user defined list of locations or files for sources meeting the predefined similarity until a match is found or the end of the list has been reached.

At step 264, the system checks whether a match has been found (i.e. that this is why searching has paused) and, if so, processing continues at step 266 where the found source is grouped with the others (if any) already found and the position of the found source is stored in a list maintained by the system as a database or in a file.

If, at step 264, the system determines that a match had not been found (and hence that the end of the list had, instead, been reached), processing continues at step 268 where the system outputs the results of the search to a display or printer. At step 270, the user would typically inspect or check the results (on the display or printout) and, if at step 272 the user confirms (such as by activating an ‘accept’ icon) that the results are satisfactory, processing continues at step 274 where the system sets the split viewer and CAMII according to the grouped groups. At step 276, the system outputs the results to the display and processing ends.

If at step 272 the user does not confirm that the results are satisfactory (such as by activating a ‘reject’ icon), processing ends.

Modifications within the scope of the invention may be readily effected by those skilled in the art. For example, although the system of FIG. 1—comprising software stack 10—is located on a single computing device, in other embodiments the system may be distributed. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in any country.

1. A computer-implemented system for creating or managing layouts, comprising:
a browser application; and
one or more display clients for rendering data-oriented views;
wherein said browser application is user-operable to select or locate data sources and to select data-oriented views and thereby to control said browser application to control said display clients to render said selected data-oriented views based on said selected data sources.

2. A system as claimed in claim 1, wherein said browser application includes an icon module for generating increment icons, said increment icons being user-operable to select said data sources and said data-oriented views.

3. A system as claimed in claim 1, wherein said system is configure to operate either supervised or unsupervised.

4. A system as claimed in claim 1, wherein said system is controllable to establish connections between computing devices and perform an analysis, and to output results of said analysis according to user definable settings.

5. A system as claimed in claim 1, wherein said system is controllable to search for said data sources according to one or more user-defined search criteria.

6. A system as claimed in claim 5, wherein said one or more user-defined search criteria comprise similarity in one or more user-defined parameters to within a user-defined tolerance.

7. A system as claimed in claim 1, wherein said data-oriented views comprise display elements, said display clients rendering said data-oriented views by rendering said display elements.

8. A system as claimed in claim 1, wherein said browser application includes a module for inviting one or more display clients to render said display elements constituting a data-oriented view or views, and for handling return states.

9. A system as claimed in claim 1, including a UUID module operable by a user to associate a data-oriented view with a universal unique identifier, and configured to make said universal unique identifier available to a display client or clients responsible for rendering said data-oriented view and to said browser application.

10. A system as claimed in claim 9, wherein said UUID module comprises GUI elements and methods.

11. A system as claimed in claim 1, further comprising:
a synchronization service for providing persistent storage and synchronization of records pertaining to said data-oriented views;
a metadata service for creating, storing, accessing, discovering and exchanging metadata; and
an application launch service for allowing said browser application to open one or more display clients.

12. A system as claimed in claim 1, including an event notification system for managing notifications across multiple tasks.

13. A system as claimed in claim 1, including a metadata service configured to control displaying of data source metadata presented for browsing or operation of said increment icons.

14. A computer-implemented method for creating or managing layouts, comprising:
operating a browser application to select or locate data sources and to select data-oriented views; and
controlling said browser application to control said display clients to render said selected data-oriented views based on said selected data sources.

15. A method as claimed in claim 14, including generating increment icons with a module of said browser application, and operating said increment icons to said select data sources and said data-oriented views.

16. A method as claimed in claim 14, including employing a metadata service to control display of data source metadata presented for browsing or operation of said increment icons.

17. A method as claimed in claim 14, including searching for said data sources according to one or more user-defined search criteria.

18. A method as claimed in claim 14, wherein said one or more user-defined search criteria comprise similarity in one or more user-defined parameters to within a user-defined tolerance.
